(19) United States
(12) Patent Application Publication
(10) Pub. No.: US 2012/0323641 A1
(43) Pub. Date: Dec. 20, 2012

(54) TERMINAL PERFORMANCE ANALYTICAL COMPUTER SYSTEM

(75) Inventor: King Fung Chu, Kowloon (CN)

(73) Assignee: Accenture Global Services Limited, Dublin (IE)

(21) Appl. No.: 13/164,437

(22) Filed: Jun. 20, 2011

(51) Int. Cl. G06Q 10/00

(52) U.S. Cl. 705/7.39

(57) ABSTRACT

A computer system with a data extraction, aggregation and analytical engine is provided for analyzing data for services, resources and activities data for container port terminal performance. The computer system implements a method that receives data associated with services, activities, and resources provided for customers from data collection source systems; defines a multidimensional relationship between the data for a service, an activity, and a resource consumed for an individual movement of a container for an individual customer; determines from the received data individual cost items for the individual movement of the container; stores the allocated individual cost items in a terminal performance database in relation to corresponding customers and in relation to dates when those costs were incurred; maps, from the terminal performance database into a multidimensional database, the allocated costs for services to corresponding activities and the allocated costs for resources to corresponding activities; and generates a report in a user interface of a display device to illustrate costs associated with one or more dimensions selected from the group consisting of individual customers, a specific service, a specific activity, and a specific resource over specified periods of time.

### BACKGROUND

The port industry is characterized by substantial infrastructure investments and significant competition between ports. A port is generally made up of a multiple shipping terminals from which ships and barges are loaded and unloaded to move goods in and out of the port. Frequently the goods are shipped in containers, which may also be referred to as containerized cargo. The containers may also be moved between terminals. Movements of the containers incur costs of services, activities, and resources required to load, unload, and move the containers. Profits can only be realized when revenue from services performed by a port company exceed expenses or costs affiliated with the resources and activities required to perform those services.

Solutions for scaling up and down quickly to meet immediate transportation demands have become an imperative for port operations. Information Technology (IT) capabilities help provide answers to port infrastructure creation or expansion-related issues. From an investment and revenue generation perspective, quick operationalization has to go hand-in-hand with choosing the right time for capacity enhancements and project launches. Fast and efficient operationalization to streamline business processes and IT systems helps reduce the need of working capital, and leads to early revenue generation by making the ports functional and traffic-worthy within a short time. Thus, port assets start generating returns sooner.

Operationalization of new port projects can be jumpstarted by: integrating the corporate function of the existing port operators and investors with that of the new terminals; leveraging the best practices of the port operators and investors, and implant them in the new terminals; and ensuring good project management throughout the capacity expansion.

Port operators and investors, however, often fail to achieve these objectives due to common shortcomings. For instance, they may have little experience in integrating new business units into different corporate functions, e.g., managing transformation from a single operation mode to multiple business unit corporate management modes. The operators and investors may further fail to capture easy-to-leverage best practices in a standardized form that can be replicated for implementing new terminals.

Also, even after identifying an efficient course of action for their terminals, port companies often face the absence of an IT computer systems integrator to manage the project to help verify that all capabilities in different areas are seamlessly integrated into the computer systems. Port companies may lack resources, skills, and/or a port-specific integrated technical solution for focusing on specific information processes. Neither enterprise resource planning systems nor business intelligence solutions have industry vertical solution targeting for port operations.

### BRIEF SUMMARY

Computer systems and methods consistent with the present disclosure provide automated port terminal data dissection, extraction, analytics, and report generation. The system and method may be used to provide dashboard, graph, and data analytical reports that inform a port operator of resource and activity costs, revenue, and profit at a granular level of an individual container level for consumed services, as well as in summary format for specified time periods.

In one embodiment of the invention, a data processing system is disclosed for analyzing services, resource and activities data for container port terminal performance. The system includes a data integration interface that receives services, activities, and resources data associated with customers of the container port terminal from a plurality of data collection source systems. A data integration component may be coupled with the data integration interface to transform the received data.

An activity-based cost allocation engine receives the transformed data and allocates individual cost items based on a multidimensional relationship defined between data for a service, an activity, and a resource consumed for an individual movement of a container for an individual customer. A terminal performance database stores the respective allocated individual cost items. A calculation engine maps data of the allocated individual cost items from the terminal performance database into a multidimensional database. A reporting component generates reports in a user interface illustrating costs associated with one or more dimensions, including individual customers, a specific service, a specific activity, and a specific resource over specified periods of time.

According to another embodiment of the invention, a computer-implemented method of analyzing data for services, resources and activities data for container port terminal performance is provided. The method includes receiving data associated with services, activities, and resources provided for a plurality of customers of a port container terminal from a plurality of data collection source systems, the data collection source systems including operations and enterprise management computer systems of a port container terminal; defining a multidimensional relationship between the data for a service, an activity, and a resource consumed for an individual movement of a container for an individual customer; and determining from the received data individual cost items for the individual movement of the container by calculating and allocating direct costs and indirect costs for the service, activity and resource consumed by the individual movement of the container according to the defined multidimensional relationship;

The method further includes storing the allocated individual cost items in a terminal performance database in relation to corresponding customers and in relation to dates when those costs were incurred; mapping, from the terminal performance database into a multidimensional database, the allocated costs for services to corresponding activities and the allocated costs for resources to corresponding activities; and generating a report in a user interface of a display device to illustrate costs associated with one or more dimensions selected from the group consisting of individual customers, a specific service, a specific activity, and a specific resource over specified periods of time.

In yet another embodiment of the invention, a data processing system for analyzing services, activities and resources data for port container terminal performance is disclosed that includes a computing system having a processor and memory, the memory including instructions executable by the processor. The computer is configured to receive data associated with services, activities, and resources data associated with customers of the container port terminal from a plurality of data collection source systems, the data collection source systems including operations and enterprise management computer systems of a port container terminal, among others.

The processor executes instructions to: transform the received data into a unified, harmonized data set; retrieve a multidimensional relationship between data for a service, an activity, and a resource consumed for an individual movement of a container for an individual customer; determine costs of the individual movement of the container by calculating and allocating direct costs and indirect costs for the service, activity and resource consumed by the individual movement of the container according to the retrieved multidimensional relationship based on the transformed data; store the determined costs in a terminal performance database in relation to corresponding customers and in relation to dates when those costs were incurred; map, from the terminal performance database into a multidimensional database, the allocated costs for services to a corresponding plurality of dimensions; and generate a report in a user interface of a display device to illustrate costs associated with one or more dimensions selected from the group consisting of individual customers, a specific service, a specific activity, and a specific resource over specified periods of time.

In still another embodiment of the invention, a data processing system for analyzing services, resource and activities data for container port terminal performance includes: means for receiving data associated with services, activities, and resources provided for a plurality of customers of a port container terminal from a plurality of data collection source systems; means for defining a multidimensional relationship between the data for a service, an activity, and a resource consumed for an individual movement of a container for an individual customer; means for determining individual cost items from the received data by calculating and allocating costs for the service, activity and resource consumed by the individual movement of the container according to the defined multidimensional relationship; means for storing the allocated individual cost items in a terminal performance database in relation to corresponding customers and in relation to dates when those costs were incurred; means for mapping, from the terminal performance database into a multidimensional database, the allocated costs for services to corresponding activities and the allocated costs for resources to corresponding activities; and means for generating a report in a user interface of a display device to illustrate costs associated with one or more dimensions selected from the group consisting of individual customers, a specific service, a specific activity, and a specific resource over specified periods of time.

The subject matter described in this specification may be implemented as a device, possibly in the form of a computer system or one or more computer program products for use on a computing system, or as a method being carried out with use of such a device. The subject matter described in the specification may be implemented in a machine readable medium, where the medium is embodied in one or more information carriers, such as a CD-ROM, a DVD-ROM, a data signal, a semiconductor memory, or a hard disk. Such computer program products may cause a data processing apparatus to perform one or more operations described in the specification.

In addition, subject matter described in the specification can also be implemented as a computing system including a processor, and a memory coupled to the processor. The memory may encode one or more programs to cause the processor to perform one or more of the methods described in the specification. Further subject matter described in the specification can be implemented using various machines.

Moreover, the subject matter described in this specification may be implemented using a variety of programming languages and tools including Visual Basic for Applications (VBA) or Visual Basic.

Details of one or more implementations are set forth in the accompanying exemplary description and drawings below. Other features will be apparent from the description and drawings, as well as from the claims.

### BRIEF DESCRIPTION OF DRAWINGS

FIG. 1 is a diagram of a terminal performance management system (“TPMS”), including an activity-based cost allocation engine for allocating costs among services, activities, and resources.

FIG. 2 is a data-flow diagram of the terminal performance management system of FIG. 1.

FIG. 3 is a diagram of a cost model of the terminal performance management system of FIGS. 1 and 2 analyzed from a dimensional perspective and from a perspective of direct and indirect cost allocation.

FIG. 4 is a diagram of the processing engines of a back-end of the terminal performance management system of FIG. 1 that resolve costs from cost-related data and profit numbers based additionally on revenue data.

FIG. 5 is a data sheet showing dimensions of a data cube, correlated to a measure group type, which is used to provide data sliced by type for computing cost-based analysis by the terminal performance management system of FIG. 1.

FIG. 6 depicts a three-indexed database, one each for resources, activities, and services consumed at a port terminal, and their three-dimensional, mutual relationship as saved in memory.

FIG. 7 depicts an exemplary datasheet created through dissecting and extracting the mutual relationship between activities and services of the multidimensional database of FIG. 6.

FIG. 8 depicts an exemplary datasheet created through dissecting and extracting the mutual relationship between activities and resources of the multidimensional database of FIG. 6.

FIG. 9 is an exemplary user interface through which an operator may specify anticipated types of activities and resources related to specific services made available at a port terminal to customize the terminal performance management system of FIG. 1 for individual customers.

FIG. 10 is an exemplary graph report of monthly costs per volume by container service, which may be generated by front-end tools of the terminal performance management system of FIG. 1.

FIG. 11 is an exemplary graph report of operations costs, displaying revenue generating activities and non-revenue generating activities in the same screen, which may be generated by front-end tools of the terminal performance management system of FIG. 1.

FIG. 12 is an exemplary data report of monthly activities costs by unit broken down as a percentage of total operations costs, which may be generated by front-end tools of the terminal performance management system of FIG. 1.

FIG. 13 shows a schematic diagram of an exemplary computer system.

### DETAILED DESCRIPTION AND PREFERRED EMBODIMENTS

In the following text, a detailed description of examples will be given with reference to the drawings. It should be understood that various modifications to the examples may be made. In particular, elements of one example may be combined and used in other examples to form new examples.

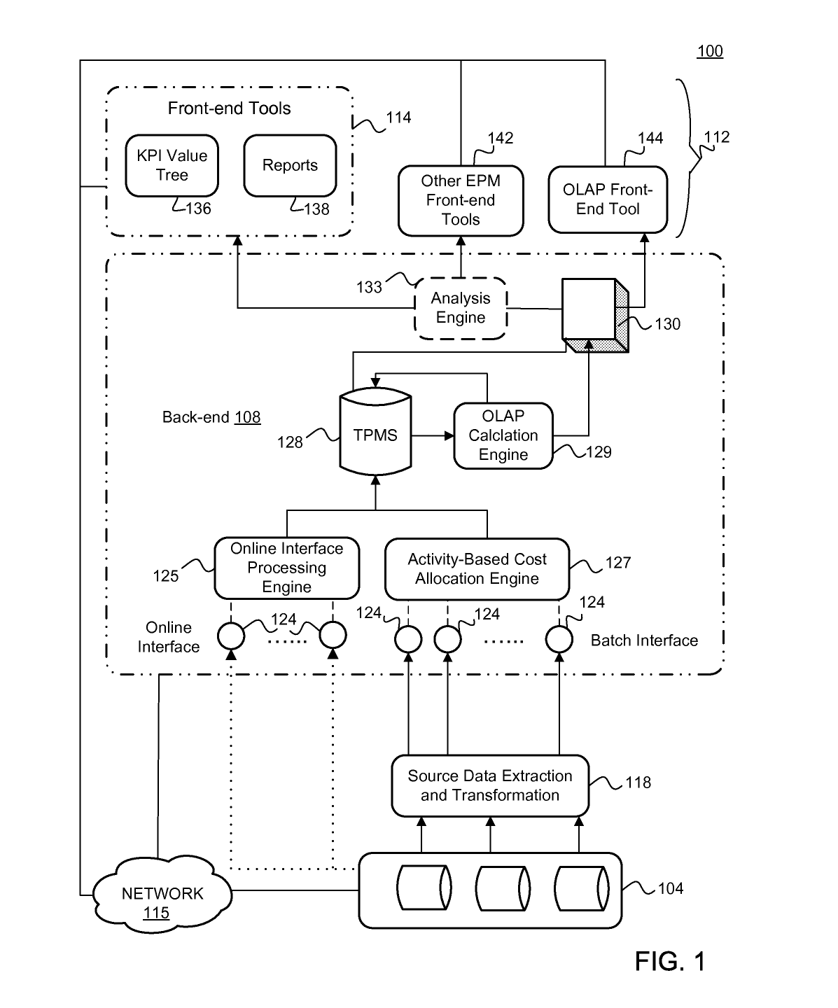

FIG. 1 is a diagram of a terminal performance management system (TPMS) 100. The system 100 may include a number existing terminal computers and systems (“existing/client systems”) 104 such as for operations and enterprise management that will provide data to be fed into a back-end 108 of the system 100 that will perform cost-based analysis on the data as will be discussed. Sources of data from the existing systems 104 may include, but are not limited to (i) external data from client systems; (ii) manual data input screens; and (iii) other external data sources such as a spreadsheet upload. The system 100 also may include a presentation layer 112 including a number of front-end tools 114 for report generation that will also be discussed. The system 100 may further include a network 115 through which the existing systems 104, the back-end 108, and the front-end tools 114 may communicate or though which they may be coupled with each other. Herein, the phrase “coupled with” is defined to mean directly connected to or indirectly connected through one or more intermediate components. The intermediate components may include those of the network 115. The network 110 may include the Internet or World Wide Web (“Web”), a wide area network (“WAN”), a local area network (“LAN”), and/or an extranet, to which may be connected through either a wired or wireless connection.

The system 100 may further include a source data extraction and transformation component 118 that may receive or extract data from the existing systems 104 and transform this data into a format that the back-end 108 can interpret. The network 115 may include structure or components that may be considered a part of the extraction and transformation component 118. The existing systems 104 may include many of the infrastructure feeding systems belonging to a port company such as enterprise resource planning (ERP), SAP, Oracle, Excel, and other database-driven systems or from outside systems such as legacy systems.

The back-end 108 may include a plurality of integration interfaces 124 which may be further classified as batch interfaces or online interfaces that integrate data from the existing systems 104 into a compatible or unified whole, harmonized for subsequent analysis. The back-end 108 may further include an online interface processing engine 125 and an activity-based costing allocation engine 127 coupled with a TPMS database 128. The back-end 108 may further include an online analytical processing (OLAP) engine 129 configured to map data from the TPMS database 128 into a multidimensional database (or “OLAP cube” database) 130 from which the presentation layer 112 may dissect and extract data to create cost-based reports. Alternatively or in addition, an analysis engine 133 may be employed in the back-end 108 to dissect and extract the mapped data in the multidimensional database 130 for use by the presentation layer 112.

In further detail, the batch interfaces 124 may include pre-defined tables within the TPMS database 128 that allows data to be fed into the back-end 108 for processing. The batch interfaces 124 may include a trans-coder and integrator module (not shown) for trans-coding and integration of internal and external Master Data. Trans-coding is the process of transforming the format and representation of content to make it universally accessible. This module allows for the integration of disparate data into a unified and harmonized data structure universally accessible to the TPMS back-end 108 analytical modules and engines. The online interfaces 124 are available in the form of open standard Web services that allow for online integration of data, if required, in a process similar to that executed by the batch interfaces.

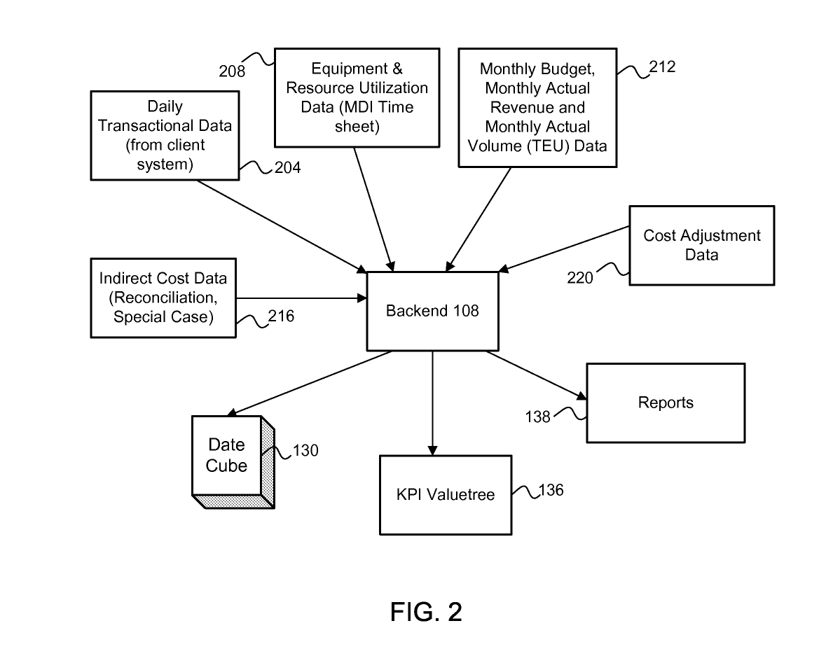

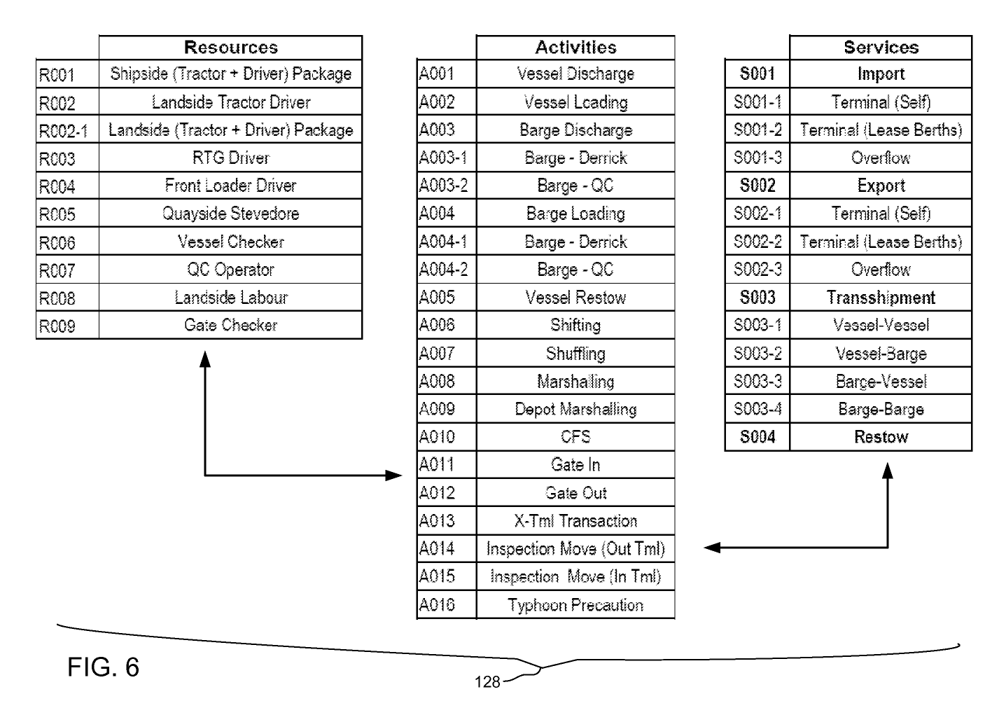

The activity-based cost allocation engine 127—or the online interface processing engine 125 for data received through the online interfaces 124—is configured to associate or allocate direct and indirect costs of activities in relation to resources and services for identified customers on an individual item basis. These direct and indirect costs will be discussed in more detail with reference to FIGS. 2 through 4. Allocated costs are then stored in the TPMS database 128 in relation to their respective activities, resources, and services. The OLAP calculation engine 129 then maps data of the allocated individual cost items from the TPMS database 128 into the multidimensional (or OLAP cube) database 130. FIG. 6 is an example of how resources and services may both be saved in relation to activities in the multi-dimensional database 128, creating at least a three-dimensional data structure with at least three different types of cost items.

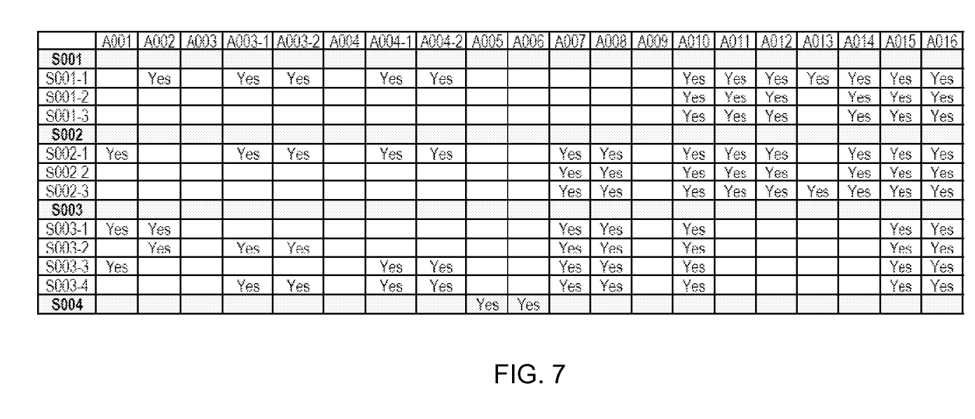

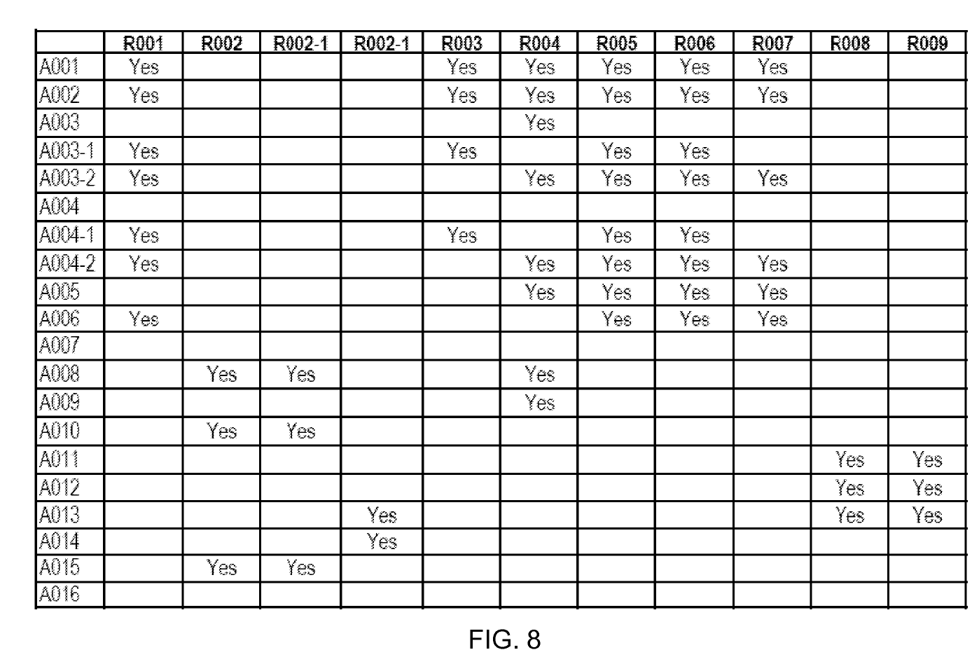

The analysis engine 133 and/or some reporting component in the presentation layer 112, such as within the front-end tools 114, may dissect and extract the data from the TPM database 128 such as to flatten the data to two dimensions capable of being presented to a user interface for a port operator or other user to consider costs associated with the individual movement of one or more container(s). FIG. 7 is an example datasheet created through dissecting and extracting the mutual relationship between activities and services of the multidimensional database 128 of FIG. 6. FIG. 8 is an example datasheet created through dissecting and extracting the mutual relationship between activities and resources of the multidimensional database 128 of FIG. 6. The analysis engine 133 may perform the dissection and extraction in response to a signal from the presentation layer 112 indicative of a request for data stored in two or more dimensions of the multidimensional database 130.

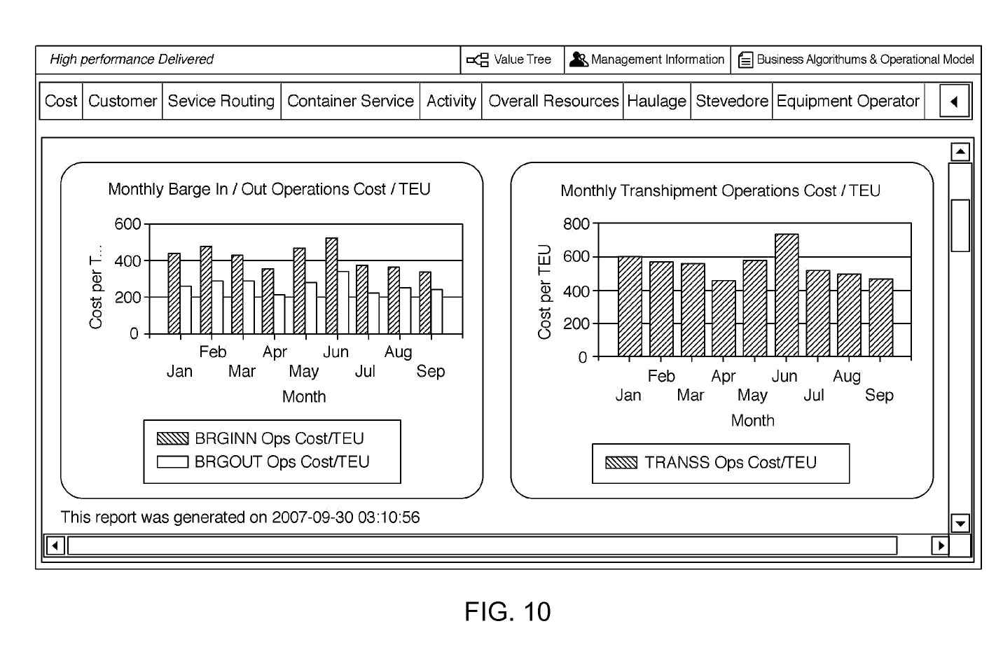

One or more of the front-end tools 114 of the presentation layer 112 may generate reports in a user interface with the dissected and extracted data to illustrate costs associated with one or more of the following dimensions over specified periods of time: individual customers, a specific service, a specific activity, and a specific resource. The front-end tools 114 may include a reporting component that returns the data from the two or more dimensions with a relationship between the data from the two or more dimensions in a report that presents to users periodic costs of activities in relation to one or more of the services and resources for one or more customers. The front-end tools 114 may include a set of custom-developed Web pages as well as SQL server reporting services reports. Examples of reports will be discussed with reference to FIGS. 10 through 12.

The front-end tools 114 may include a key performance indicator (“KPI”) value tree component 136 and a reporting component 138 that are custom developed for the TMPS system 100. The system 100 may, however, may be integrated with additional or different front-end tools, including other enterprise project management front-end tools 142, and/or OLAP front-end tools 144. These front-end tools 142 and 144 may include other business intelligence or scorecard front-end tools such as Performancepoint Server developed by Microsoft of Redmond, Washington. This flexibility allows port operators and users to integrate with existing systems.

The KPI value tree component 136 may analyze extracted data to generate a set of business measurements that are organized and grouped based on a field-tested performance tracking model. The value tree structure results in one or more value levers used for shareholder value creation for port enterprises. Corresponding KPIs are customized for each value lever and presented as a “node” in the value tree structure. The tree-structure interface includes extra links so that users can locate main branches in a tree-like display for different KPIs, such as return on investment capital (“ROIC”), profit, revenue, operating margin, cost, and top customer profitability. The KPI values may be monthly based and grouped by KPI node in data tables stored in memory. A dashboard may be used to present data in the value tree structure to C-level executives who can easily visualize the healthiness of their enterprise by tracking the status of fulfillment of each KPI target.

Without an activity-based costing model, such as the one disclosed herein, clients can only review average costs. The present model enables customer-specific and activity-specific cost review. The terminal port industry is characterized by substantial infrastructure investments and significant competition between ports. This has translated to a very customer-centric focus as port operators develop their strategies on which customers and operations they need to invest in to win in the market. The data from the disclosed model may be generated in reports that may be analyzed by a port operator or user. The disclosed system and methods enable a detailed review of customer activity-based costs and enable the operator to make decisions on where to focus their operational and/or sales strategies based on the financial attractiveness of a particular customer or service. The data can also be used to control hard equipment and supply usage more efficiently and/or personnel more efficiency, for example, increase profits.

When using the disclosed system and cost model, a software prototype may be customized to client specifics, who can then conduct multidimensional analysis that supports their strategy formulation. Furthermore, for capital-intensive industries like ports, understanding the cost drivers at the activity level can help them initiate business process improvements projects to minimize operational expenses and avoid over-spending on capital expenses.

Examples of services that may be ordered by a customer of a port operator may include, but not be limited to, activities related to import, export, transshipment, and restow (FIG. 6). A restow operation includes a consecutive set of unloading and loading movements of specified cargo on a ship to reposition how the cargo is stowed. Examples of resources include but are not limited to: shipside package, landside tractor driver, landside package, Rubber Tyre Gantry Crane (RTG) driver, front loader driver, quayside Stevedore, vessel checker, quality control (“QC”) operator, landside labor, and gate checker (FIG. 6). Examples of activities include, but are not limited to: vessel discharge, vessel loading, barge discharge, barge quality control (“QC”), vessel restow, shifting, marshaling, cross-terminal (X-Tml) transaction, inspection move (out Terminal or In Terminal), and typhoon precaution (FIG. 6). As shown in FIG. 6, these resources, services, and activities may be interrelated and costs may be allocated to them on an individual cost basis per cost item. These costs may further be allocated in terms of a container movement to provide cost-based analysis at the discrete, container level.

FIG. 2 is a data-flow diagram of the terminal performance management system (TPMS) 100 of FIG. 1, showing a hub-and-spoke design for the flow of data in and out of the back-end 108. At block 204, daily transactional data from existing client systems 104 are passed to the back-end 108. At block 208, equipment and resource utilization data is sent from MDI time sheets to the back-end 108. At block 212, monthly budget, monthly actual revenue, and monthly actual volume (typically in twenty-foot equivalent units (TEU)) data is sent to the back-end 108 from the client systems or data input 104. At block 216, indirect cost data, including reconciliation and special case or unusual expenses data are sent to the back-end 108 from the client systems or data input 104. At block 220, cost adjustment data is sent to the back-end 108 to properly adjust various costs figures or values as already entered into the back-end 108 of the system 100.

Allocated direct and indirect costs of activities are saved in relation to resources and services for identified customers on an individual item basis in the TPMS database 128. The OLAP calculation engine 129 may then map data of the allocated individual cost items from the TPMS database 128 into the multidimensional (or OLAP cube) database 130. The direct and indirect costs, as allocated, may also be sent to the KPI value tree component 136 as well as the reporting component 138 as discussed with reference to FIG. 1.

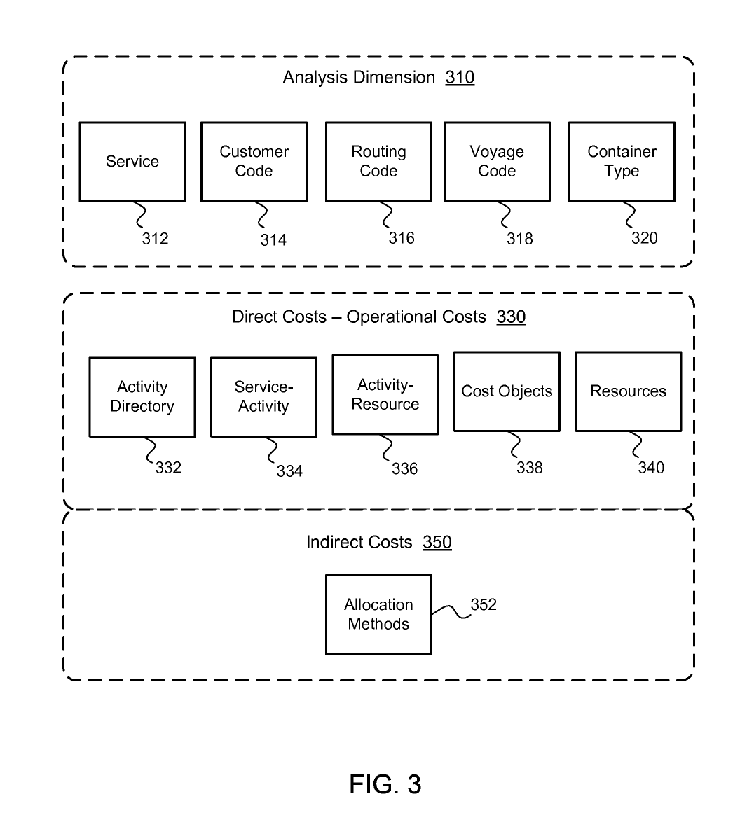

FIG. 3 is a diagram of a cost model of the terminal performance management system of FIGS. 1 and 2 analyzed from a dimensional perspective and from a perspective of direct and indirect cost allocation.

A dimension 310 for cost-based analysis may include, but not be limited to, a service 312, a customer code 314, a routing code 316, a voyage 318, or a container type 320. Additional or different analysis dimensions are envisioned depending on the customization applied to a specific port terminal. The service 312 may include import, export, transshipment, and restow as shown in FIG. 6. Underneath import or export, the services may further be broken down as self-import terminal, lease berths terminal, and overflow. Underneath transshipment, the services may further be broken down a vessel-to-vessel, vessel-to-barge, barge-to-vessel, or barge-to-barge.

The customer code 314 may include a unique designation or indication saved in relation to specific corresponding customers, for purposes of tracking cost-based items in memory as related to those customers. The routing code 316 may include a unique designation or indication saved in relation to specific corresponding service companies, for the purposes of tracking cost-based items in memory that may be affiliated with resources and/or activities needed to perform an ordered service. These service companies may include third parties sub-contracted to perform a portion of an ordered service. The voyage code 318 may include a unique designation or indication saved in relation to specific corresponding voyages, for purposes of tracking cost-based items in memory that may be affiliated with the specific voyage. The customer code 314, the routing code 316, and the voyage code 318 may be registered on a per customer basis by a port operator or user.

The container type 320 may include a unique designation or indication saved in relation to specific types of containers, for purposes of tracking an individual shippable container that may be filled with goods for shipment or other means of delivery. Examples of containers may be broken down as empty, laden (or filled), and uncovered and the sizes of the same. The costs per container 320 may also be broken down by resource and/or activity that may be allocated to movement of that container 320.

Data related to costs may be broken down between direct (or operational) costs data 330 and indirect costs data 350. The direct costs data 330 may include but not be limited to an activity directory 332, a service-activity cost 334, an activity-resource cost 336, cost objects 338, and resources data 340. The activity directory 332 may be instantiated like the Activities table of FIG. 6 that lists customized activities relevant to a particular port terminal. The service-activity data 334 may include service and activity data saved in memory in mutual relation such as shown in FIG. 7. The activity-resource data 336 may include activity and resource data saved in memory in mutual relation such as shown in FIG. 8. The cost objects 338 may include other or similar cost data quantified per item and per dimension. The resources data 340 may include data saved in memory in relation to the available resources such as shown in the Resources table of FIG. 6. Additional or different direct costs may be enumerated as customized by a port operator or other user.

A number of indirect costs 350 may include but are not limited to electricity, water, and other utilities or terminal-wide costs that are not attributable to one or more specific dimensions. At block 352, a number of allocation methods may be used to allocate these indirect costs 350 across the one or more dimensions. One of the allocation methods 352, for instance, may include allocating the indirect costs as a fractional average to one or more activities relevant to a resource.

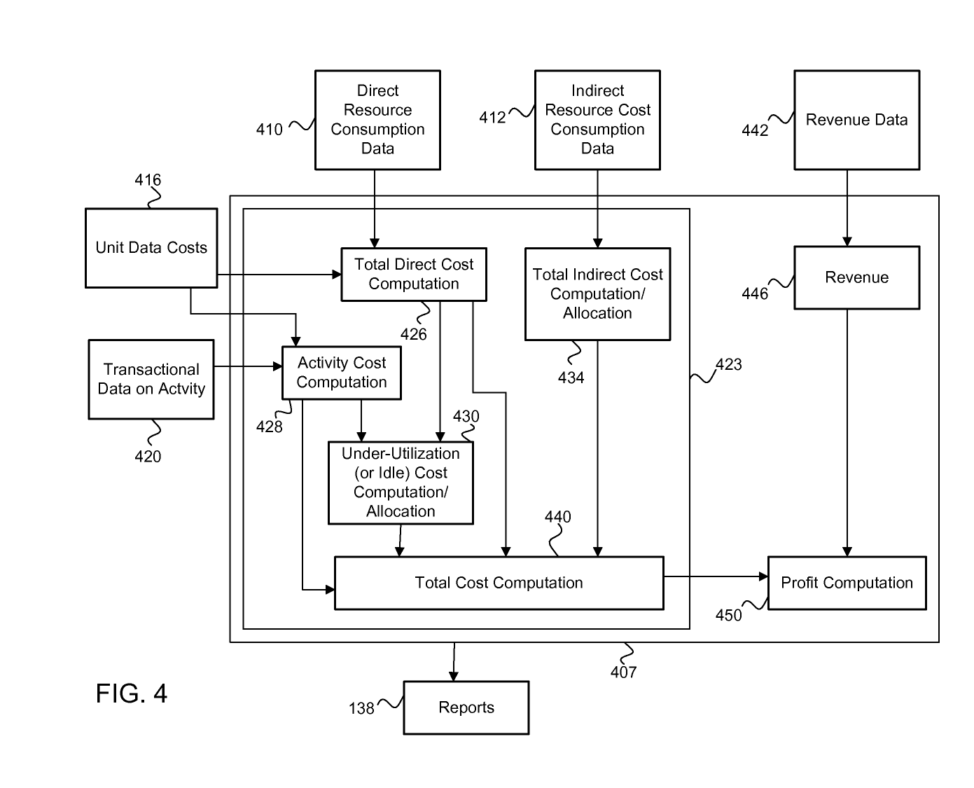

FIG. 4 is a diagram of the processing engines 125, 127, 129, and 133 of the back-end 128 of the terminal performance management system 100 of FIG. 1 that allocate costs from cost-related data and determine profit based on revenue data. A good portion of the processing may be performed by the activity-based cost allocation engine 127 (and/or the online interface processing engine 125), but processing may also be shared with the OLAP calculation engine 129 and the analysis engine 133 depending on from where the data is pulled to perform the processing and what kind of processing occurs. Accordingly, for simplicity, these processing engines 125, 127, 129, and 133 may be referred to jointly as a TPM processing engine 407 of the back-end 108.

The processing engine 407 may receive a number of different kinds of data as follows: direct resource consumption data 410 (such as total consumption of time, per container, and the like), indirect resource cost consumption data 412 (such as electricity or other utilities), unit data costs 416, and transactional data on activities 420 (such as activity consumption of time, per container, and per type of activity, e.g., TEU, Box, Move, and the like). A cost computation component 423 of the processing engine 407 may then execute a series of computations to determine a total cost of for a service, which includes activities, resources, and indirect costs associated with performance of the service. The computations or calculations may be carried out by a series of algorithms that act on the received cost-based data.

At block 426, the processing engine 407 receives the direct resource consumption data 410 and the unit data costs 416 and computes an expected total direct cost. The expected total direct cost may be calculated for an activity associated with an ordered service. The total direct cost may include one or more of: a number of hours ordered times an hourly rate of one or more employees and a number of units ordered times a unit cost for materials.

At block 428, the processing engine 407 receives the unit data costs 416 and the transactional data on activities 420, determines a resource consumed by the activity, and calculates an activity consumption cost of the resource as one or more of: a number of hours consumed times the hourly rate and a number of units consumed times the unit cost for materials.

At block 430, the processing engine 407 computes an under-utilization (or idle) cost associated with the resource as the expected total direct cost minus the activity consumption cost and allocates the idle cost as a fractional average to the activity, which is an activity among a plurality of activities relevant to the consumed resource. When the idle cost is known for one or more specific activities, the cost allocation engine directly allocates the known idle cost to the corresponding specific activities.

At block 434, the processing engine 407 receives indirect resource cost consumption data 412 and calculates consumed indirect costs for a resource associated with an ordered service as one or more of: a number of hours consumed times an hourly rate of one or more employees and a number of units consumed times a unit cost for materials. The processing engine 407 may also allocate the indirect costs as a fractional average to one or more activities relevant to the resource.

At block 440, the processing engine 407 computes total cost consumption for the activity and/or for a resource related to the activity. The total cost consumption may include adding the direct, indirect, and idle costs as allocated to the activity and/or resource expended to perform an ordered service.

At block 442, revenue data 442 is passed to the processing engine 407. At block 446, the processing engine receives the revenue data 442 and computes the revenue earned from performing the ordered service. At block 450, the processing engine receives the total cost computation and the revenue and computes the profit from performing the ordered service. The processing engine 407 may send the direct and indirect costs, the total computation costs, the revenue, and the profit to the reporting component 138 discussed earlier to populate reports in an executive dashboard or any kind of report viewable by users through a user interface.

Furthermore, the processing engine 407 at block 446 may compute expected revenue for services yet unperformed. The computation at block 440 may also determine total expected costs as allocated to specific activities and resources for an ordered service. Accordingly, the profit computation at block 450 may also include expected profits in addition to the real profit computation performed as already discussed.

In some instances, a provisional cost is determined for costs that are still unknown. The processing engine 407, for instance at block 426, may determine a resource to be consumed by an activity associated with an ordered service; determine there are no known costs associated with the resource; and estimate a provisional cost of the resource as one or more of: a number of hours estimated to be consumed times an hourly rate of one or more employees and a number of units estimated to be consumed times a unit cost for materials. The processing engine 407 may then allocate the provisional cost as a fractional average to the activity, which is an activity among a plurality of activities relevant to the resource in a current time period. The processing engine 407 may further determine a difference between an actual cost consumed by the activity, once known, and the provisional cost, and allocate the difference as a cost to a subsequent time period for the activity. These provisional costs may be estimated for both direct and indirect costs and then allocated to specific resources expected to be needed to perform the ordered service.

In some cases, the actual cost of a resource may have to be adjusted after report posting, e.g., the wrong data is input into total stevedore hours, and needs to be adjusted afterwards. This is an example of the cost adjustment data 220 referred to in FIG. 2. For such cases, the actual cost should be inputted to the processing engine 407 again, which then initiates a recalculation of costs based on the adjusted data.

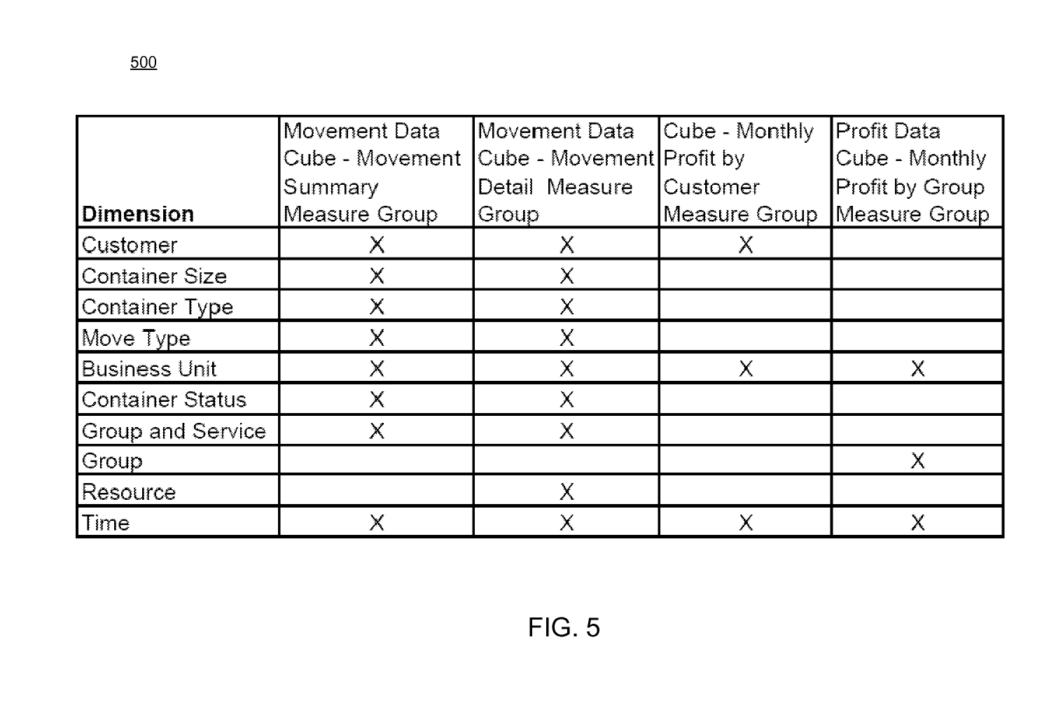

FIG. 5 is a data sheet 500 showing dimensions of the data cube 130 (or multidimensional database 130) correlated to a measure group type, which is used to provide data sliced by type for computing cost-based analysis by the activity-based cost allocation engine of FIG. 1. A number of dimensions may be arrayed along one side of the data sheet while measurement groups of related data may be arrayed along the other side of the data sheet to form various data cubes. The dimensions may include but are not limited to: customer; container size; container type; move type; business unit; container status; group and service; group; resource; and time. Any of these dimensions may be correlated with one or more measure groups of data. For instance, arrayed along the top of the data sheet 500 may include but not be limited to: (1) movement data cube including a movement summary measure group; (2) movement database cube including a movement detail measure group; (3) profit data cube including monthly profit by customer measure group; and (4) profit data cube including monthly profit by group measure group.

With more specificity, the dimensions may be defined as follows for use in software processing of the processing engine 407. The Customer dimension refers to a shipping line company that includes a Customer Key and Customer Name attributes. The Container Size dimension includes a container size attribute. The Container Type dimension includes a container type attribute. The Move Type dimension relates to a movement type hierarchy including but not limited to the following attributes: Move Type Key; Sub Move Type Key; and Sub Move Type Name. The Business Unit dimension includes Business Unit Key and Business Unit attributes. The Container Status dimension includes a container status attribute. The Group and Service dimension includes a group and service hierarchy including but not limited to the following attributes: Group Key; Service Key; and Name Field. The hierarchy of the Group and Service dimension may include two levels, Group Key and Service Key. The Group dimension includes but is not limited to the following attributes: Group Key and Group Name. The Resource dimension includes but is not limited to the following attributes: Resource Key and Resource Name. The Time dimension summarizes measures by various hierarchy levels. Two of the hierarchies include, but are not limited to: Year-Quarter-Month-Date and Year-Week-Date. The time refers to the movement time—in movement data cube—and the period of the profit, where in the profit data cube, it is based on month.

With more specificity, the measure groups may be defined as follows for use in software processing of the processing engine 407. The Movement Summary Measure Group may include but not be limited to the following Measure Names and Descriptions: (1) Twenty-foot equivalent unit (TEU) for each movement, which is not stored directly in a table, but is calculated from the size of the container of the movement; and (2) Movement Count where each movement is counted as one. The Movement Detail Measure Group may include but not be limited to the following Measure Names and Descriptions: (1) Direct Cost—the total of actual direct cost, which is consumed by a resource defined as “direct resource,” including categorized under-utilized cost and un-categorized under-utilized cost; and (2) Consumed Cost—the actual direct cost, which is consumed by a resource defined as “direct resource;” (3) Idle Cost—the sum of categorized under-utilized cost and un-categorized under-utilized cost; and (4) Indirect Cost—the sum of indirect cost and overhead cost.

The Profit by Customer Measure Group may include but not be limited to the following Measure Names and Descriptions: (1) Total Revenue—the monthly revenue, by customer, inputted manually into the system 100 or received from client systems or external data source 104; (2) Total Cost—the sum of movement total cost group by customer; and (3) Total Profit—calculated as the Total Revenue minus the Total Cost. The Profit by Group Measure Group may include but not be limited to the following Measure Names and Descriptions: (1) Total Revenue—the monthly revenue, by group, inputted manually into the system 100 or received from a client system or external data source 104; (2) Total Cost—the sum of movement total cost group by group; and (3) Total Profit—calculated as the Total Revenue minus the Total Cost.

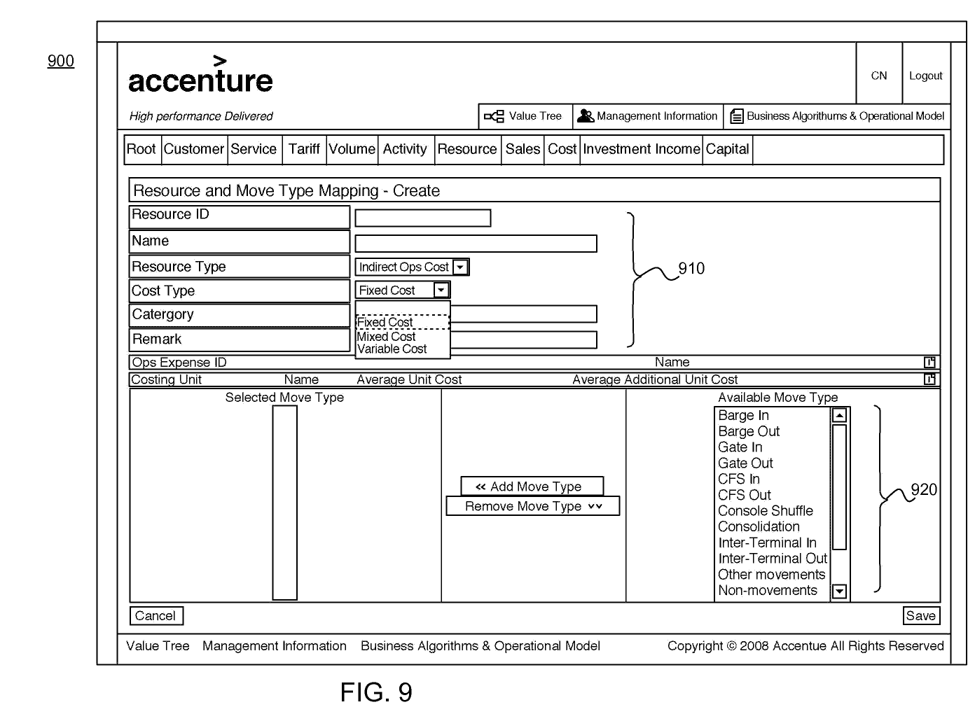

FIG. 9 is an exemplary user interface 900 through which an operator may specify anticipated types of activities and resources related to specific services made available at a port terminal to customize the terminal performance management system (TPMS) 100 of FIG. 1 for individual customers. Within the user interface 900 are a plurality of data boxes into which a port operator or user enters information for customizing the dimensions and parameters of the system 100. A first section 910 on the user interface 900 includes data boxes for specifying resources, including a resource identification (“ID”), a name, a resource type (such as indirect or direct), a cost type (such as fixed or variable), and a category. A second section 920 of the user interface 900 includes a list of Move Types that may be selected as activities that will be needed to carry out anticipated services associated with a resource. Accordingly, the resource customized in the first section 910 may be related to one or more activities in the second section 920, and their mutual relationships are stored in memory such as shown in FIG. 8 as multiple resources are customized and related to different potential sets of activities.

FIG. 10 is an exemplary graph report 1000 of monthly costs per volume by container service, which may be generated by front-end tools of the TPMS 100 of FIG. 1. This kind of report is possible due to the ability of the analysis engine 133 to dissect and extract the required data from the multidimensional database 130. For instance, these bar graphs show monthly barge in and barge out costs per TEU and monthly transshipment operations costs per TEU. An operator can see that barge in operation costs were high in May and June, but decreased into the fall. The operator can also see that transshipment operations costs have maintained fairly steady except for a spike in June.

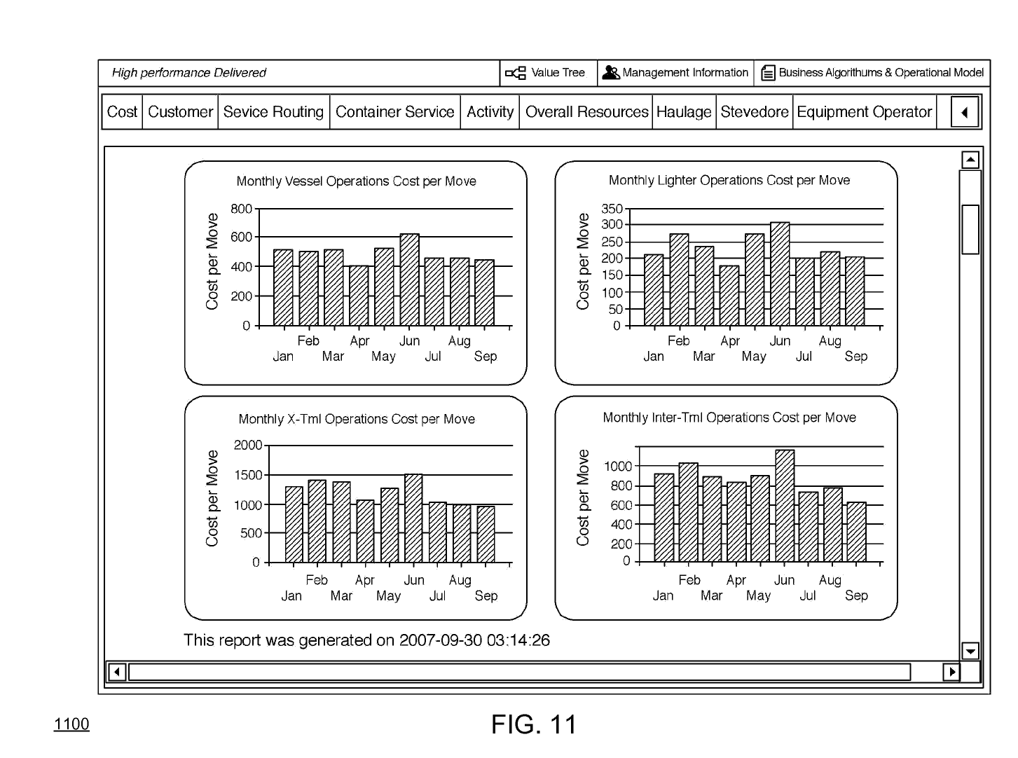

FIG. 11 is an exemplary graph report 1100 of operations costs, displaying revenue generating activities and non-revenue generating activities in the same screen, which may be generated by front-end tools of the TPMS 100 of FIG. 1. This kind of report is possible due to the ability of the analysis engine 133 to dissect and extract the required data from the multidimensional database 130 and the function of the processing engine 407 (FIG. 4). The top set of graphs or charts show costs of revenue generating activities, in this case the vessel operations cost per move and lighter operations cost per move. When a “move” is referred to, this may also be understood to refer to a service performed for a customer. The bottom set of graphs show costs of non-revenue generating activities, in this case cross-terminal operations cost per move and inter-terminal cost per move. The bottom set of graphs show cost for their respective activities running well above budget, and therefore are not generating revenue.

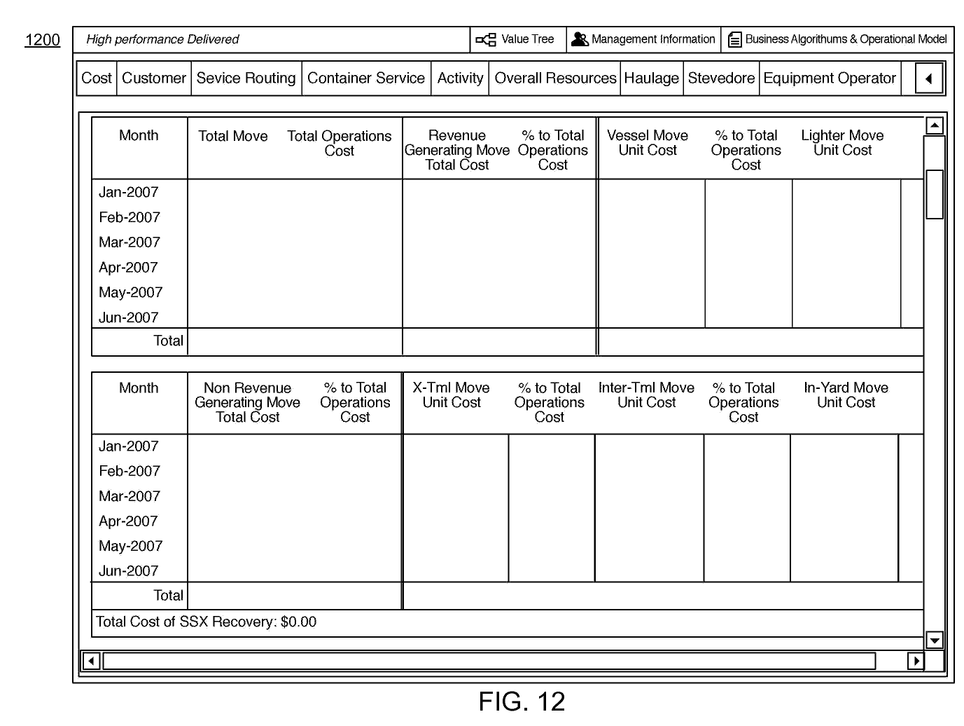

FIG. 12 is an exemplary data report 1200 of monthly activities costs by unit broken down as a percentage of total operations costs, which may be generated by the front-end tools 114 of the TPMS 100 of FIG. 1. This kind of report is possible due to the ability of the analysis engine 133 to dissect and extract the required data from the multidimensional database 130. The data report 1200 provides total moves and total operations costs, and then also breaks down individual activities costs over monthly time periods. Because of the ability to show percentages of total operation costs for each monthly unit move cost for each activity, an operator can easily inspect the data report 1200 to identify activities that are costing too much as a percentage of total costs for a move or service.

The data report 1200 also breaks down the costs between revenue-generating moves (in the top graph) and non-revenue-generating moves (the bottom graph) similar to what is displayed in the graph report 1100 of FIG. 11. Total costs for the revenue-generating moves and the percentage of total costs are first shown in the top, followed by those activities associated with the revenue-generating moves. Total costs for the non-revenue-generating moves and the percentage of total costs are first shown in the bottom, followed by those activities associated with non-revenue-generating moves.

Additional or different reports are contemplated; those of FIGS. 10 through 12 are merely examples of the types of reports and report templates that may be generated for analysis and consideration by port operators. Other examples of reports may include but are not limited to: (1) profitability by customer; (2) cost/TEU by customer; (3) cost/TEU by container services (Export, Import, Transshipment) similar to or different than FIG. 10; (4) cost per activity (vessel loading, vessel, discharge, etc.); (5) cost of resources by utilization; and (6) profit forecast reports. All of these reports generated from data pulled from the multidimensional database 130 and/or the TPMS database 128 provide a detailed review of customer-based or activity-based costs. These reports therefore enable the port operator to make decisions on where to focus their operational and/or sales strategies based on the financial attractiveness of a particular customer or service.

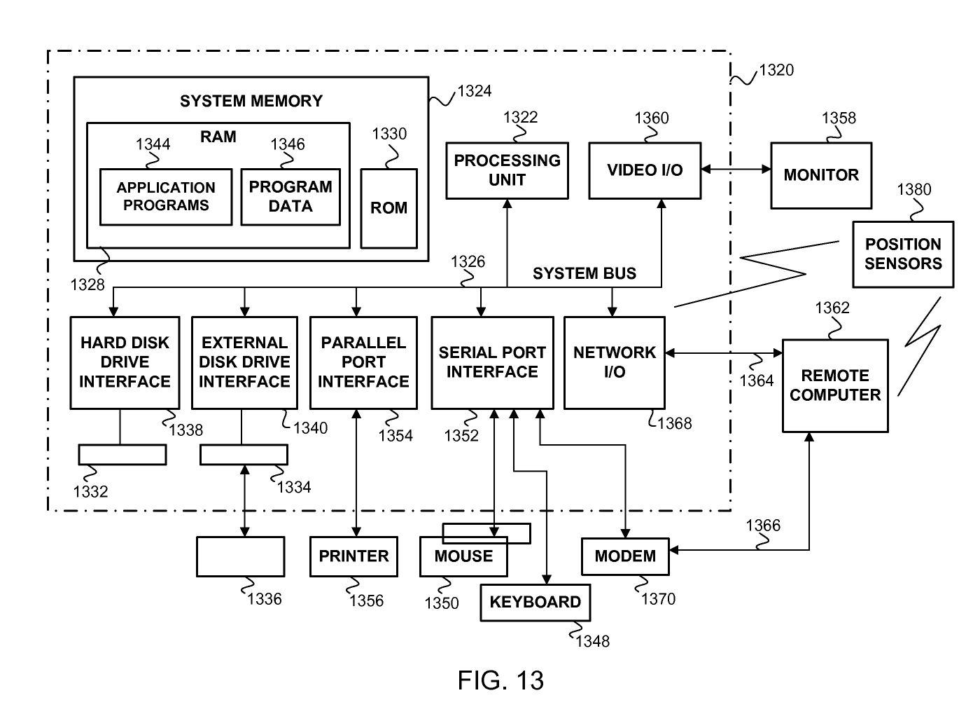

FIG. 13 shows an exemplary system for implementing aspects of the disclosure including a general purpose computing device in the form of a conventional computing environment 1320 (e.g., a computer workstation, also referred to as a user computer). The conventional computing environment includes a processing unit 1322, a system memory 1324, and a system bus 1326. The system bus couples various system components including the system memory 1324 to the processing unit 1322. The processing unit 1322 may perform arithmetic, logic and/or control operations by accessing the system memory 1324. The system memory 1324 may store information and/or instructions for use in combination with the processing unit 1322. The system memory 1324 may include volatile and non-volatile memory, such as a random access memory (RAM) 1328 and a read only memory (ROM) 1330. A basic input/output system (BIOS) containing the basic routines that helps to transfer information between elements within the computer workstation 1320, such as during start-up, may be stored in the ROM 1330. The system bus 1326 may be any of several types of bus structures including a memory bus or memory controller, a peripheral bus, and a local bus using any of a variety of bus architectures.

The computer workstation 1320 may further include a hard disk drive 1332 for reading from and writing to a hard disk (not shown), and an external disk drive 1334 for reading from or writing to a removable disk 1336. The removable disk may be a magnetic disk for a magnetic disk driver or an optical disk such as a CD ROM for an optical disk drive. The hard disk drive 1332 and the external disk drive 1334 are connected to the system bus 1326 by a hard disk drive interface 1338 and an external disk drive interface 1340, respectively. The drives and their associated computer-readable media provide nonvolatile storage of computer readable instructions, data structures, program modules and other data for the user computer 1320. The data structures may include relevant data for the implementation of the method of analyzing data for services, resources and activities data for container port terminal performance, as described above. The relevant data may be organized in a database, for example a relational or object database.

Although the exemplary environment described herein employs a hard disk (not shown) and an external disk 1336, it should be appreciated by those skilled in the art that other types of computer readable media which can store data that is accessible by a computer, such as magnetic cassettes, flash memory cards, digital video disks, random access memories, read only memories, and the like, may also be used in the exemplary operating environment.

A number of program modules may be stored on the hard disk, external disk 1336, ROM 1330 or RAM 1328, including an operating system (not shown), one or more application programs 1344, other program modules (not shown), and program data 1346. The application programs may include at least a part of the functionality as depicted in FIGS. 1 to 12.

A user may enter commands and information, as discussed below, into the personal computer 1320 through input devices such as keyboard 548 and mouse 1350. Other input devices (not shown) may include a microphone (or other sensors), joystick, game pad, scanner, or the like. These and other input devices may be connected to the processing unit 1322 through a serial port interface 552 that is coupled to the system bus 1326, or may be collected by other interfaces, such as a parallel port interface 1354, game port or a universal serial bus (USB). Further, information may be printed using printer 1356. The printer 1356 and other parallel input/output devices may be connected to the processing unit 1322 through parallel port interface 1354. A monitor 1358 or other type of display device is also connected to the system bus 1326 via an interface, such as a video input/output 1360. In addition to the monitor, computing environment 1320 may include other peripheral output devices (not shown), such as speakers or other audible output.

The computing environment 1320 may communicate with other electronic devices such as a computer, telephone (wired or wireless), personal digital assistant, television, or the like. To communicate, the computer environment 1320 may operate in a networked environment using connections to one or more electronic devices. FIG. 13 depicts the computer environment networked with remote computer 1362. The remote computer 1362 may be another computing environment such as a server computer, a router, a network PC, a peer device or other common network node, and may include many or all of the elements described above relative to the computing environment 1320. The logical connections depicted in FIG. 13 include a local area network (LAN) 1364 and a wide area network (WAN) 1366. Such networking environments are commonplace in offices, enterprise-wide computer networks, intranets and the Internet and may particularly be encrypted.

When used in a LAN networking environment, the computing environment 1320 may be connected to the LAN 1364 through a network I/O 1368. When used in a WAN networking environment, the computing environment 1320 may include a modem 1370 or other means for establishing communications over the WAN 1366. The modem 1370, which may be internal or external to computing environment 1320, is connected to the system bus 1326 via the serial port interface 1352. In a networked environment, program modules depicted relative to the computing environment 1320, or portions thereof, may be stored in a remote memory storage device resident on or accessible to remote computer 1362. Furthermore, other data relevant to of monitoring and tracking application usage (described above) may be resident on or accessible via the remote computer 1362. It will be appreciated that the network connections shown are exemplary and other means of establishing a communications link between the electronic devices may be used.

FIG. 13 depicts the computer environment 1320 also wirelessly networked with a plurality of position sensors 1380 such as global positioning system (GPS) sensors or the like that are attached to individual containers. The position sensors 1380 may also communicate wirelessly with the computer environment 1320 through the remote computer 1362. The computer environment 1320 may therefore track individual containers by container type or other associated data, and compare expected location or destinations with current position. Such positioning data may also be associated with costs or timing of the allocation of costs that affects the activity-based costing model disclosed herein. For instance, positioning data and timing of positioning data from the position sensors 1380 as associated with respective containers may inform the transaction data on activity data 420 and the direct resource consumption data 410 disclosed with reference to FIG. 4.

The above-described computing system is only one example of the type of computing system that may be used to implement the method of monitoring and tracking application usage.

We claim:

1. A data processing system for analyzing services, resource and activities data for container port terminal performance, comprising:
a data integration interface that receives services, activities, and resources data associated with customers of the container port terminal from a plurality of data collection source systems;
a data integration component coupled with the data integration interface to transform the received data;
an activity-based cost allocation engine receiving the transformed data that allocates individual cost items based on a multidimensional relationship defined between data for a service, an activity, and a resource consumed for an individual movement of a container for an individual customer;
a terminal performance database that stores the respective allocated individual cost items;
a calculation engine that maps data of the allocated individual cost items from the terminal performance database into a multidimensional database; and
a reporting component to generate reports in a user interface illustrating costs associated with one or more dimensions selected from the group consisting of individual customers, a specific service, a specific activity, and a specific resource over specified periods of time.

2. The data processing system of claim 1, where the allocated individual cost items include direct costs and indirect costs, where the cost allocation engine calculates a direct cost associated with a consumed service to determine the direct costs and calculates a fractional average cost associated with one or more of the services and resources to determine the indirect costs.

3. The data processing system of claim 1, where the cost allocation engine calculates an expected direct cost for an activity associated with an ordered service as one or more of: a number of hours ordered times an hourly rate of one or more employees; and a number of units ordered times a unit cost for materials.

4. The data processing system of claim 3, where the cost allocation engine determines a resource consumed by the activity; and calculates an activity consumption cost of the resource as one or more of: a number of hours consumed times the hourly rate; and a number of units consumed times the unit cost for materials.

5. The data processing system of claim 4, where the cost allocation engine calculates an idle cost associated with the resource as the expected direct cost minus the activity consumption cost and allocates the idle cost as a fractional average to the activity, which is an activity among a plurality of activities relevant to the consumed resource.

6. The data processing system of claim 5, where when the idle cost is known for one or more specific activities, the cost allocation engine directly allocates the known idle cost to the corresponding specific activities.

7. The data processing system of claim 1, where the cost allocation engine:
calculates consumed indirect costs for a resource associated with an ordered service as one or more of: a number of hours consumed times an hourly rate of one or more employees; and a number of units consumed times a unit cost for materials; and
allocates the indirect costs as a fractional average to one or more activities relevant to the resource.

8. The data processing system of claim 1, further comprising:
an analysis engine to dissect and extract the mapped data in the multidimensional database in response to a signal indicative of a request for data stored in two or more dimensions of the multidimensional database;
where the reporting component returns the data from the two or more dimensions and a relationship between the data from the two or more dimensions in a report that presents to a user periodic costs of activities in relation to one or more of the services and resources for one or more customers.

9. A method of analyzing data for services, resources and activities data for container port terminal performance, comprising:
receiving data associated with services, activities, and resources provided for a plurality of customers of a port container terminal from a plurality of data collection source systems, the data collection source systems including operations and enterprise management computer systems of a port container terminal;
defining a multidimensional relationship between the data for a service, an activity, and a resource consumed for an individual movement of a container for an individual customer;
determining from the received data individual cost items for the individual movement of the container by calculating and allocating direct costs and indirect costs for the service, activity and resource consumed by the individual movement of the container according to the defined multidimensional relationship;
storing the allocated individual cost items in a terminal performance database in relation to corresponding customers and in relation to dates when those costs were incurred;
mapping, from the terminal performance database into a multidimensional database, the allocated costs for services to corresponding activities and the allocated costs for resources to corresponding activities; and
generating a report in a user interface of a display device to illustrate costs associated with one or more dimensions selected from the group consisting of individual customers, a specific service, a specific activity, and a specific resource over specified periods of time.

10. The method of claim 9, further comprising calculating an expected direct cost for an activity associated with an ordered service as one or more of: a number of hours ordered times an hourly rate of one or more employees; and a number of units ordered times a unit cost for materials.

11. The method of claim 10, further comprising:
determining a resource consumed by the activity; and
calculating an activity consumption cost of the resource as one or more of: a number of hours consumed times the hourly rate; and a number of units consumed times the unit cost for materials.

12. The method of claim 11, further comprising:
calculating an idle cost associated with the resource as the expected direct cost minus the activity consumption cost; and
allocating the idle cost as a fractional average to the activity, which is an activity among a plurality of activities relevant to the consumed resource.

13. The method of claim 9, further comprising:
calculating consumed indirect costs for a resource associated with an ordered service as one or more of: a number of hours consumed times an hourly rate of one or more employees; and a number of units consumed times a unit cost for materials; and
allocating the indirect costs as a fractional average to one or more activities relevant to the resource.

14. The method of claim 9, further comprising:
dissecting and extracting the mapped data in the multidimensional database in response to a signal indicative of a request for data stored in two or more dimensions of the multidimensional database; and
sending the data from the two or more dimensions with a relationship between the data from the two or more dimensions to a report that presents to a user periodic costs of activities in relation to one or more of the services and resources for one or more customers.

15. The method of claim 14, further comprising:
retrieving real and expected revenue from performing the one or more services;
calculating expected profit as the expected revenue minus the cost of at least some of the activities;
calculating real profit as the real revenue minus the cost of at least some of the activities; and
including in the report one or more of the real and expected profits in relation to one or more of the services and resources for the one or more customers.

16. A data processing system for analyzing services, activities and resources data for port container terminal performance, comprising:
a computing system comprising a processor and memory, the memory including instructions executable by the processor;
the computer configured to receive data associated with services, activities, and resources data associated with customers of the container port terminal from a plurality of data collection source systems, the data collection source systems including operations and enterprise management computer systems of a port container terminal;
the processor executing instructions to:
transform the received data into a unified, harmonized data set;
retrieve a multidimensional relationship between data for a service, an activity, and a resource consumed for an individual movement of a container for an individual customer;
determine costs of the individual movement of the container by calculating and allocating direct costs and indirect costs for the service, activity and resource consumed by the individual movement of the container according to the retrieved multidimensional relationship based on the transformed data;
store the determined costs in a terminal performance database in relation to corresponding customers and in relation to dates when those costs were incurred;
map, from the terminal performance database into a multidimensional database, the allocated costs for services to a corresponding plurality of dimensions; and
generate a report in a user interface of a display device to illustrate costs associated with one or more dimensions selected from the group consisting of individual customers, a specific service, a specific activity, and a specific resource over specified periods of time.

17. The data processing system of claim 16, where the processor further executes instructions to:
dissect and extract the mapped data in the multidimensional database in response to a signal indicative of a request for data stored in two or more dimensions of the multidimensional database; and
return the data from the two or more dimensions and a relationship between the data from the two or more dimensions in a report that presents to a user periodic costs of activities in relation to one or more of the services and resources for one or more customers.

18. The data processing system of claim 17, where the processor further executes instructions to:
retrieve expected revenue from performing the one or more services;
calculate expected profit as the expected revenue minus the cost of at least some of the activities; and
include in the report the expected profits in relation to one or more of the services and resources for the one or more customers.

19. The data processing system of claim 16, where the processor further executes instructions to:
determine a resource to be consumed by an activity associated with an ordered service;
determine there are no known costs associated with the resource;
estimate a provisional cost of the resource as one or more of: a number of hours estimated to be consumed times an hourly rate of one or more employees; and a number of units estimated to be consumed times a unit cost for materials; and
allocate the provisional cost as a fractional average to the activity, which is an activity among a plurality of activities relevant to the resource in a current time period.

20. The data processing system of claim 19, where the processor further executes instructions to:
determine a difference between an actual cost consumed by the activity, once known, and the provisional cost; and
allocate the difference as a cost to a subsequent time period for the activity.

21. The data processing system of claim 20, where the resource comprises an indirect resource and the provisional and actual costs comprise indirect provisional and indirect actual costs, respectively.

22. A data processing system for analyzing services, resource and activities data for container port terminal performance, comprising:
means for receiving data associated with services, activities, and resources provided for a plurality of customers of a port container terminal from a plurality of data collection source systems;
means for defining a multidimensional relationship between the data for a service, an activity, and a resource consumed for an individual movement of a container for an individual customer;
means for determining individual cost items from the received data by calculating and allocating costs for the service, activity and resource consumed by the individual movement of the container according to the defined multidimensional relationship;
means for storing the allocated individual cost items in a terminal performance database in relation to corresponding customers and in relation to dates when those costs were incurred;
means for mapping, from the terminal performance database into a multidimensional database, the allocated costs for services to corresponding activities and the allocated costs for resources to corresponding activities; and
means for generating a report in a user interface of a display device to illustrate costs associated with one or more dimensions selected from the group consisting of individual customers, a specific service, a specific activity, and a specific resource over specified periods of time.

23. The system of claim 22, where the costs include direct and indirect costs, further comprising:
means for calculating an expected direct cost for an activity associated with an ordered service as one or more of: a number of hours ordered times an hourly rate of one or more employees; and a number of units ordered times a unit cost for materials.

24. The system of claim 23, further comprising:
means for determining a resource consumed by the activity; and
means for calculating an activity consumption cost of the resource as one or more of: a number of hours consumed times the hourly rate; and
a number of units consumed times the unit cost for materials.

25. The system of claim 24, further comprising:
means for calculating an idle cost associated with the resource as the expected direct cost minus the activity consumption cost; and
means for allocating the idle cost as a fractional average to the activity, which is an activity among a plurality of activities relevant to the consumed resource.

26. The system of claim 22, where the costs include direct and indirect costs, the indirect costs including terminal-wide expenses, the system further comprising:
means for calculating consumed indirect costs for a resource associated with an ordered service as one or more of: a number of hours consumed times an hourly rate of one or more employees; and a number of units consumed times a unit cost for materials; and
means for allocating the indirect costs as a fractional average to one or more activities relevant to the resource.

27. The system of claim 22, further comprising:
means for dissecting and extracting the mapped data in the multidimensional database in response to a signal indicative of a request for data stored in two or more dimensions of the multidimensional database; and
means for sending the data from the two or more dimensions with a relationship between the data from the two or more dimensions to a report that presents to a user periodic costs of activities in relation to one or more of the services and resources for one or more customers.

28. The system of claim 27, further comprising:
means for retrieving real and expected revenue from performing the one or more services;
means for calculating expected profit as the expected revenue minus the cost of at least some of the activities;
means for calculating real profit as the real revenue minus the cost of at least some of the activities; and
means for including in the report one or more of the real and expected profits in relation to one or more of the services and resources for the one or more customers.
